(19) United States
(12) Patent Application Publication
(10) Pub. No.: US 2026/0221299 A1
(43) Pub. Date: Jul. 30, 2026

(54) METHOD AND APPARATUS FOR MEASURING ACTIVITY CONCENTRATION IN THE PRIMARY CIRCUIT OF THE HIGH TEMPERATURE GAS-COOLED REACTOR

(71) Applicant: Tsinghua University, Beijing (CN)

(72) Inventors: Feng Xie, Beijing City (CN); Yu Wang, Beijing City (CN); Jianzhu Cao, Beijing City (CN); Yujie Dong, Beijing City (CN); Zuoyi Zhang, Beijing City (CN)

(21) Appl. No.: 19/459,426

(22) Filed: Jan. 26, 2026

(30) Foreign Application Priority Data
Jan. 26, 2025 (CN) 202510124376.1

(51) Int. Cl. G21C 17/028; G21C 17/04

(52) U.S. Cl. CPC G21C 17/028; G21C 17/044

(57) ABSTRACT

The present application improves the accuracy of activity concentration measurement for the primary circuit of an HTGR. A method includes the following: the first activity concentration of the reference object under the current operating condition is determined from the operating parameters of the current operating condition together with the calculation parameters of the reference object; likewise, the first activity concentration of the nuclide to be measured is determined from the same operating parameters and the calculation parameters of that nuclide. The second activity concentration of the reference object under the current operating condition is obtained through the primary circuit activity concentration measurement. Using the first activity concentration of the nuclide to be measured, the first activity concentration of the reference object, and the experimentally determined second activity concentration of the reference object, the second activity concentration of the nuclide to be measured under the current operating condition is derived.

### CROSS-REFERENCE TO RELATED APPLICATIONS

This application claims priority to Chinese Patent Application No. 2025101243761, filed on Jan. 26, 2025, which is hereby incorporated by reference in its entirety.

### TECHNICAL FIELD

The present disclosure pertains to the source term and radiation monitoring in radiation safety and protection of nuclear energy applications and specifically relates to a method and apparatus for measuring activity concentration in the primary circuit of a High Temperature Gas-cooled Reactor.

### BACKGROUND

One important foundation of the inherent safety of the High Temperature Gas-cooled Reactor (HTGR) is the adoption of fuel elements containing TRistructural ISOtropic (TRISO) coated particles, which are capable of retaining the large majority of fission products under both normal operating conditions and accident scenarios. However, coated particle failures generated during fuel-element fabrication, uranium contamination arising from manufacturing processes, natural uranium contamination in the matrix graphite, possible irradiation-induced failures of coated particles during reactor operation, and activation of impurities in the core graphite materials and in the coolant, may all result in the presence of primary-circuit source terms in the helium coolant of the HTGR under normal operating conditions.

The radioactive level in the primary circuit of an HTGR is of critical importance for assessing both the performance of fuel elements in the core and the radiological safety of the reactor. On one hand, the activity concentration of fission products in the primary circuit-particularly the noble-gas fission products directly reflects the status of the TRISO coated particles in the fuel elements. On the other hand, it forms the basis for determining the source terms associated with effluent discharge, the secondary circuit and other process systems, as well as accident source terms. Determination of the fission product radioactivity in the primary circuit is generally achieved through two approaches: direct measurement of the radioactivity in the primary helium coolant and calculation of the primary circuit radioactivity. In experimental studies, the radioactivity level is typically obtained through online measurement of the total γ-activity concentration in the primary-circuit pipelines, or through offline γ-spectrometric analysis of sampled helium from the primary circuit. However, these measurements usually correspond to operating periods when the reactor is at stable, normal conditions, leading to considerable uncertainties for radionuclides with short half-lives. Furthermore, sampling halogen fission nuclides is difficult due to the complex sampling procedures required in the primary circuit, making it challenging to accurately determine their activity concentrations. Consequently, it remains an important technical challenge in the field to develop a method capable of measuring the activity concentration in the primary circuit with improved accuracy and more information.

### SUMMARY

Aiming at the problems in the prior art, and an apparatus for measuring the activity concentration in the primary circuit of an HTGR, which can at least partially solve the problems existing in the prior art.

In the first aspect, the present invention provides a method for measuring the activity concentration in the primary circuit of an HTGR, comprising:
obtaining a first activity concentration of a reference object under the current operating condition based on the operating parameters of the current condition and calculation parameters of the reference object, and obtaining a first activity concentration of a nuclide to be measured under the current operating condition based on the operating parameters of the current operating condition and calculation parameters of the nuclide to be measured;
acquiring a second activity concentration of the reference object under the current operating condition, wherein the second activity concentration of the reference object under the current operating condition is obtained through experimental measurement of the activity concentration in the primary circuit;
obtaining a second activity concentration of the nuclide to be measured under the current operating condition based on the first activity concentration of the nuclide to be measured under the current operating condition, the first activity concentration of the reference object under the current operating condition and the second activity concentration of the reference object under the current operating condition.

In a second aspect, the present invention provides an apparatus for measuring the activity concentration in the primary circuit of an HTGR, comprising:
an obtaining unit, configured to obtain a first activity concentration of a reference object under the current operating condition, on the basis of the operating parameters of the current operating condition and calculation parameters of the reference object, and obtain a first activity concentration of a nuclide to be measured under the current operating condition, on the basis of the operating parameters of the current operating condition and calculation parameters of the nuclide to be measured;
an acquiring unit, configured to acquire a second activity concentration of the reference object under the current operating condition, wherein the second activity concentration of the reference object under the current operating condition is obtained through experimental measurement of the activity concentration in the primary circuit;
and a measuring unit, configured to obtain a second activity concentration of the nuclide to be measured under the current operating condition, on the basis of the first activity concentration of the nuclide to be measured under the current operating condition, the first activity concentration of the reference object under the current operating condition and the second activity concentration of the reference object under the current operating condition.

In a third aspect, the present invention provides a computer device, comprising a memory, a processor and a computer program stored in the memory, wherein the processor is configured to execute the computer program to implement the method for measuring the activity concentration in the primary circuit of an HTGR according to any of the above-mentioned embodiments.

In a fourth aspect, the present invention provides a computer-readable storage medium, wherein the computer-readable storage medium stores computer programs or instructions. When executed by a processor, the computer programs or instructions realize the method for measuring the activity concentration in the primary circuit of an HTGR as described in any of the above-mentioned embodiments.

In a fifth aspect, the present invention provides a computer program product, which includes computer programs or instructions. When executed by a processor, the computer programs or instructions implement the method for measuring the activity concentration in the primary circuit of an HTGR as described in any of the above-mentioned embodiments.

The method and apparatus for measuring the activity concentration in the primary circuit of an HTGR provided in the embodiments of the present invention enable: obtaining a first activity concentration of a reference object under the current operating condition on the basis of the operating parameters of the current operating condition and calculation parameters of the reference object, and obtaining a first activity concentration of a nuclide to be measured under the current operating condition on the basis of the operating parameters of the current operating condition and calculation parameters of the nuclide to be measured; acquiring a second activity concentration of the reference object under the current operating condition, wherein the second activity concentration of the reference object under the current operating condition is obtained through experimental measurement of the activity concentration in the primary circuit; and obtaining a second activity concentration of the nuclide to be measured under the current operating condition based on the first activity concentration of the nuclide to be measured under the current operating condition, the first activity concentration of the reference object under the current operating condition and the second activity concentration of the reference object under the current operating condition, therefore accurately measuring the activity concentration of radioactive nuclides with short half-lives and enhancing the accuracy and comprehensiveness of the activity concentration measurement of nuclides in the primary circuit.

### BRIEF DESCRIPTION OF THE DRAWINGS

In order to more clearly illustrate the technical solutions in the embodiments of the present invention or the existing technology, the following will briefly introduce the attached drawing used in the description of the embodiments or the existing technology.

Obviously, the attached drawings described below are only some embodiments of the present invention. For ordinary technicians in the field, without the need for creative labor, other attached drawing can also be obtained based on these drawings. In the attached drawings:

FIG. 1 is a flowchart of a method for measuring the activity concentration in the primary circuit of an HTGR according to the first embodiment of the present invention.

FIG. 2a is a schematic diagram of the decay chain Pattern A according to the second embodiment of the present invention.

FIG. 2b is a schematic diagram of the decay chain of the nuclides ^{133m}Xe and ¹³³Xe according to the second embodiment of the present invention.

FIG. 3 is a flowchart of a method for measuring the activity concentration in the primary circuit of an HTGR according to the third embodiment of the present invention.

FIG. 4 is a flowchart of a method for measuring the activity concentration in the primary circuit of an HTGR according to the fourth embodiment of the present invention.

FIG. 5 shows the experimental measured values of the activity concentration of the fission gas nuclides in the primary circuit of the 10 MW high temperature gas-cooled experimental reactor (HTR-10) under different operating conditions according to the fifth embodiment of the present invention.

FIG. 6 shows the theoretical calculating values of the activity concentration of fission gas nuclides in the primary circuit of HTR-10 under different operating conditions according to the sixth embodiment of the present invention.

FIG. 7 shows the radioactive balance diagram in the primary circuit of HTR-10 at 10 MW power according to the seventh embodiment of the present invention.

FIG. 8 shows the theoretical ratio and experimental ratio of activity concentrations of fission gas nuclides in the primary circuit of HTR-10 under different operating conditions according to the eighth embodiment of the present invention.

FIG. 9 is a schematic structural diagram of an apparatus for measuring the activity concentration in the primary circuit of an HTGR according to the ninth embodiment of the present invention.

FIG. 10 is a schematic structural diagram of an apparatus for measuring the activity concentration in the primary circuit of an HTGR according to the tenth embodiment of the present invention.

FIG. 11 is a schematic structural diagram of an apparatus for measuring the activity concentration in the primary circuit of an HTGR according to the eleventh embodiment of the present invention.

FIG. 12 is a schematic diagram of the physical structure of a computer device according to the twelfth embodiment of the present invention.

### DETAILED DESCRIPTION OF THE PREFERRED EMBODIMENTS

To make the purpose, technical solutions, and advantages of the embodiments of the present invention clearer and more understandable, the embodiments of the present invention are described in further detail below with reference to the drawings. The illustrative embodiments and their explanations herein are provided to explain the present invention, but they do not limit the present invention. It should be noted that, without conflict, the embodiments and features of the present application can be arbitrarily combined. The technical solutions in the present application regarding the acquisition, storage, use, and processing of data all comply with the relevant provisions of laws and regulations. The user information in the embodiments of the present application is all obtained through legal and compliant means, and the acquisition, storage, use, and processing of user information have been authorized and agreed upon by the customers.

To facilitate the understanding of the technical solutions provided in the present application, the following will first explain the relevant contents of this application's technical solution.

Source term of an HTGR: refers to the types, quantities, release timing, physical and chemical states, and thermal energy of the radionuclides released from the reactor containment to the environment under normal operating conditions or hypothetical accident scenarios.

Primary circuit source term: generally refers to the types and activity levels of radioactive substances generated within the primary circuit of a nuclear reactor.

Core inventory: refers to the total amount of radioactive substances contained within the reactor core.

In the calculation of reactor source term, the radioactive source term is, in a narrow sense, specifically referring to the types and activities of radioactive nuclides, which are generally classified into normal operation source term and accident source term.

From the perspective of radiation monitoring, the primary circuit source term of an HTGR are classified into five categories: tritium, carbon-14, radioactive dust, activation products and fission products (including gaseous and solid fission products).

For short-lived gaseous fission products in HTGRs, the calculation model of the activity concentration in the primary circuit mainly comprises three components: core inventory calculation, diffusion and release of radionuclides from fuel elements in the core, and nuclide migration model in the primary circuit. The core inventory forms the basis of source term calculations and is usually determined by solving the point-depletion burnup equations of a complex coupled nuclide network to get the total activity of radioactive nuclides in the core. However, due to the wide variety and complex nature of the nuclides in the reactor core, the generation and decay process of fission products involves a large number of coupled nonlinear differential equations, making the solution of the burnup equation extremely complex. The diffusion and release calculations of halogen nuclides and fission gas nuclides in the HTGR fuel elements are all based on the Booth model, which incorporates, to varying degrees, empirical derived terms related to temperature, burnup, thermal diffusion and recoil effects, as well as the distinction between the fuel kernel and the matrix graphite. At present, two types of nuclide migration model in the primary circuit for calculating the distribution and activity concentration of fission products in the HTGR primary circuit are used: the zero-dimensional model and the one-dimensional model. The zero-dimensional model neglects non-uniformities in the physical parameters of the primary circuit in the core, and leads to a more conservative calculation results. While the one-dimensional model can account for the non-uniform physical parameters of the circuit, the results are more accurate. However, more calculation parameters are added, and the acquisition of engineering parameters is rather difficult. Moreover, the existing methods do not allow for directly obtaining the activity concentration of each fission gas nuclide in the primary circuit by measuring the total activity concentration in the primary circuit through experiment measurements.

This invention is based on existing theoretical calculation models. By establishing a new calculation model for the gaseous fission products from the core to the primary circuit in a pebble-bed HTGR, it addresses the limitations of the existing models in practical applications and improves the theoretical framework for the radioactive measurement of the gaseous fission products in the primary circuit. It also constructs a theoretical calculation framework for the activity concentration of nuclides in the primary circuit of HTGRs, combining the material performance data from ongoing research, operating parameters of the primary circuit, and the performance parameters of the fuel elements in the reactor core of an HTGR (e.g., the failure fraction of coated particles and the share of uranium contamination), to achieve accurate and comprehensive calculations of the activity concentration of nuclides in the primary circuit in the actual reactor core.

This application establishes the IPRFGN model for rapidly calculating the inventory of fission nuclides in the reactor core based on the physical relationship between short-lived noble gas fission nuclides, reactor operating parameters, reactor power and burnup, to solve the problem of large number of parameters, complexity and difficulty in obtaining in the conventional core inventory calculation methods. Based on the experimental measurement of gas fission products in the primary circuit of an HTGR at different power levels, a theoretical model for the diffusion and release of gaseous fission products from the core fuel elements to the primary circuit is constructed. A ratio method for source term analysis applicable to short-lived iodine and fission gases in the primary circuit of HTGRs is proposed, that is, a method for measuring the activity concentration in the primary circuit of an HTGR, thereby being able to measure the activity concentrations of gaseous fission products and halogen nuclides in the primary circuit.

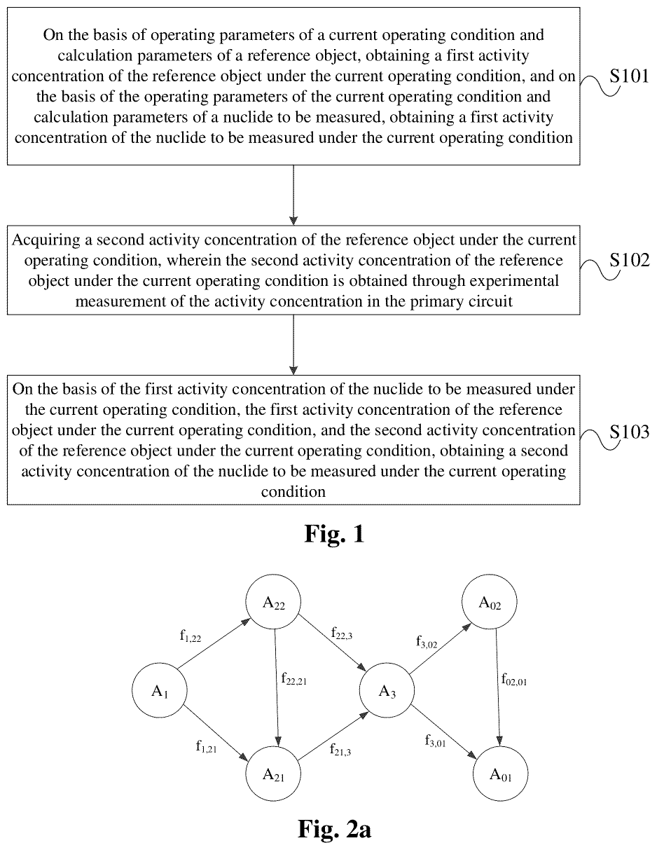

FIG. 1 is a flowchart of the method for measuring the activity concentration in the primary circuit of an HTGR according to the first embodiment of the present invention. As shown in FIG. 1, the method comprises:

S101. On the basis of operating parameters of a current operating condition and calculation parameters of a reference object, obtaining a first activity concentration of the reference object under the current operating condition, and on the basis of the operating parameters of the current operating condition and calculation parameters of a nuclide to be measured, obtaining a first activity concentration of the nuclide to be measured under the current operating condition.

Specifically, based on the established theoretical framework and computational method for activity concentration of radionuclides in the primary circuit of an HTGR, a theoretical activity concentration of the reference object under the current operating condition can be obtained, on the basis of the operating parameters under the current operating condition and the calculation parameters of the reference object, which is taken as the first activity concentration of the reference object. Likewise, on the basis of the operating parameters of the current operating condition and the calculation parameters of the nuclide to be measured, a theoretical activity concentration of the nuclide to be measured under the current operating condition can be obtained, which is taken as the first activity concentration of the nuclide to be measured under the current operating condition.

Wherein, the current operating condition refers to the actual operating condition of the HTGR in which the nuclide to be measured is located. The “reference object” refers to either a reference nuclide in the primary circuit or a set of fission gas nuclides in the primary circuit. The reference nuclide can be selected as a single short-lived noble gaseous fission nuclide, for example ^{85m}Kr, ⁸⁷Kr, ⁸⁸Kr or ¹³⁵Xe. The fission-gas nuclide set may be selected from the fission gas nuclides in the primary circuit, for example, include ^{85m}Kr, ⁸⁷Kr, ⁸⁸Kr, ⁸⁹Kr, ^{133m}Xe, ¹³³Xe, ^{135m}Xe, ¹³⁵Xe, ¹³⁷Xe, and ¹³⁸Xe.

The operating parameters of the current operating condition include reactor characteristic parameters, temperature, pressure, the purification flow rate of the helium purification system, the leakage removal coefficient of the primary circuit, the duration time per helium cycle, the duration time for the helium across the core per cycle, the equivalent removal rate, and the equivalent ratio of the release rate to birth rate of all the fuel elements in the core, etc. These are selected as required and are not limited by the embodiments of the present invention. The calculation parameters of the reference object include the core inventory of the reference object, the deposition coefficient of the nuclide, the neutron absorption cross section of the nuclide, etc. The calculation parameters of the nuclide to be measured include the core inventory of the nuclide to be measured, the deposition coefficient of the nuclide to be measured, the neutron absorption cross section of the nuclide to be measured, etc. The nuclide to be measured refers to gaseous fission products and halogen nuclides in the primary circuit of an HTGR whose activity concentration is to be measured.

S102. Acquiring a second activity concentration of the reference object under the current operating condition, wherein the second activity concentration of the reference object under the current operating condition is obtained through experimental measurement of the activity concentration in the primary circuit.

Specifically, a second activity concentration of the reference object can be obtained for different operating conditions by carrying out the experiments of activity concentration in the primary circuit. In practical application, the second activity concentration of the reference object under the current operating condition can be obtained by looking up the experimentally determined value corresponding to the current operating condition.

For example, activity concentration measurements in the primary circuit adopt an online sampling and monitoring scheme. The primary helium coolant containing radionuclides flows through the copper-oxide bed and then enters a sampling container through an inlet sampling line. After sampling and measurement, the helium coolant is discharged through an outlet line, then treated and released by a ventilation system. After the reactor has been operating at a stable power level for a period of time, a portion of the primary circuit coolant is extracted and analyzed to obtain a γ-ray spectrum of the nuclides. By analyzing this γ spectrum, the activity concentrations of radionuclides in the primary coolant are derived. The activity concentration of the radionuclides in the primary coolant is then corrected, and the second activity concentration of the reference object under the operating condition at the time of measurement is obtained. By varying the operating power of the HTGR and measuring the activity concentration of the reference object, the second activity concentration of the reference object is obtained for different operating conditions.

S103. On the basis of the first activity concentration of the nuclide to be measured under the current operating condition, the first activity concentration of the reference object under the current operating condition, and the second activity concentration of the reference object under the current operating condition, obtaining a second activity concentration of the nuclide to be measured under the current operating condition.

Specifically, a calculation relationship can be pre-established among the first activity concentration of the nuclide to be measured under the current operating condition, the first activity concentration of the reference object under the current operating condition, the second activity concentration of the reference object under the current operating condition and the second activity concentration of the nuclide to be measured under the current operating condition. After obtaining the specific values for the first activity concentration of the nuclide to be measured under the current operating condition, the first activity concentration of the reference object under the current operating condition, and the second activity concentration of the reference object under the current operating condition, the second activity concentration of the nuclide to be measured under the current operating condition can be derived by applying the above calculation relationship.

The method for measuring the activity concentration in the primary circuit of an HTGR, as provided in the embodiment of the present invention, enables the determination of the first activity concentration of the reference object under the current operating condition based on the operating parameters of the current condition and the calculation parameters of the reference nuclide. Additionally, the first activity concentration of the nuclide to be measured under the current operating condition is obtained based on the current operating parameters of the current operating condition and the calculation parameters of the nuclide to be measured. Acquiring a second activity concentration of the reference object under the current operating condition, wherein the second activity concentration of the reference object under the current operating condition is obtained through experimental measurement of the activity concentration in the primary circuit. Based on the first activity concentration of the nuclide to be measured under the current operating condition, the first activity concentration of the reference object under the current operating condition, and the second activity concentration of the reference object under the current operating condition, the second activity concentration of the nuclide to be measured under the current operating condition can be derived. This method allows for the accurate measurement of the activity concentration of short-lived radionuclides, improving the accuracy of activity concentration measurement in the primary circuit. It also enables the measurement of the activity concentration of halogen nuclides, enhancing the comprehensiveness of activity concentration measurement in the primary circuit.

The present application constructs a theoretical framework and computational method for determining the activity concentration of radioactive nuclides in the primary circuit of an HTGR, which includes the core inventory calculation IPRFGN model, the nuclide diffusion and release model, and the zero-dimensional primary circuit nuclide migration model. These three models are used to determine the core inventory, ratio of the release rate to the birth rate, and equivalent removal rate, which can be applied to the calculation of the activity concentration of nuclides in the primary circuit.

The core inventory calculation method used in this application is based on the IPRFGN model, which summarizes the decay chains of short-lived halogen nuclides and fission gas nuclides (such as ¹³³I, ¹³⁵I, ¹³³Xe, ^{133m}Xe, ¹³⁵Xe, ^{135m}Xe, ^{85m}Kr, ⁸⁹Kr, ⁸⁷Kr, ⁸⁸Kr, ¹³⁷Xe, and ¹³⁸Xe) into two modes: A (divided into four sub-modes) and B. The IPRFGN model provides an analytical solution for the core inventory as follows:

$${I}_{i} = {\sum }_{k} {c}_{k} {A}_{f , i , k} \qquad ( 1 )$$

Where, Iᵢ is the core inventory of nuclide i, cₖ is the coefficient for A_{f,i,k} of the nuclide k in the decay chain of nuclide i, k is the different nuclide designation in the decay chain of nuclide i, A_{f,i,k} is the amount of the nuclide k produced from the pre-selected fissile nuclides, which is a function of the reduced reactor power P_{final} (MW/tHM) in the final stage and the average burnup B of fuel elements of the core operating parameters:

$${A}_{{f , i , k}^{}} = {\sum }_{j} {y}_{j , k} {σ}_{f , j} {ϕ}_{2} {N}_{j} , j = U 5 , U 8 , Pu 9 , Pu 1 \qquad ( 2 )$$

Where Y_{U5,k} is the fission share of nuclide k produced by U-235 fission, Y_{U8,k} is the fission share of nuclide k produced by U-238 fission, Y_{Pu9,k} is the fission share of nuclide k produced by Pu-239 fission, and Y_{Pu1,k} is the fission share of nuclide k produced by Pu-241 fission, σ_{f,U5} is the fission cross-section of U-235, σ_{f,U8} is the fission cross-section of U-238, σ_{f,Pu9} is the fission cross-section of Pu-239, and σ_{f,Pu1} is the fission cross-section of Pu-241, σ_{a,i} is the spectrally averaged neutron absorption cross section of nuclide i, φ₂ is the equivalent neutron flux in the core, N_{U5} is the number of atoms of U-235, N_{U8} is the number of atoms of U-238, N_{Pu9} is the number of atoms of Pu-239, N_{Pu1} is the number of atoms of Pu-241. The pre-selected fissile nuclides is not limited by this application and can be chosen according to the actual composition of the fuel and experience.

As an example, the calculation process of the core inventory of ¹³³Xe is illustrated below.

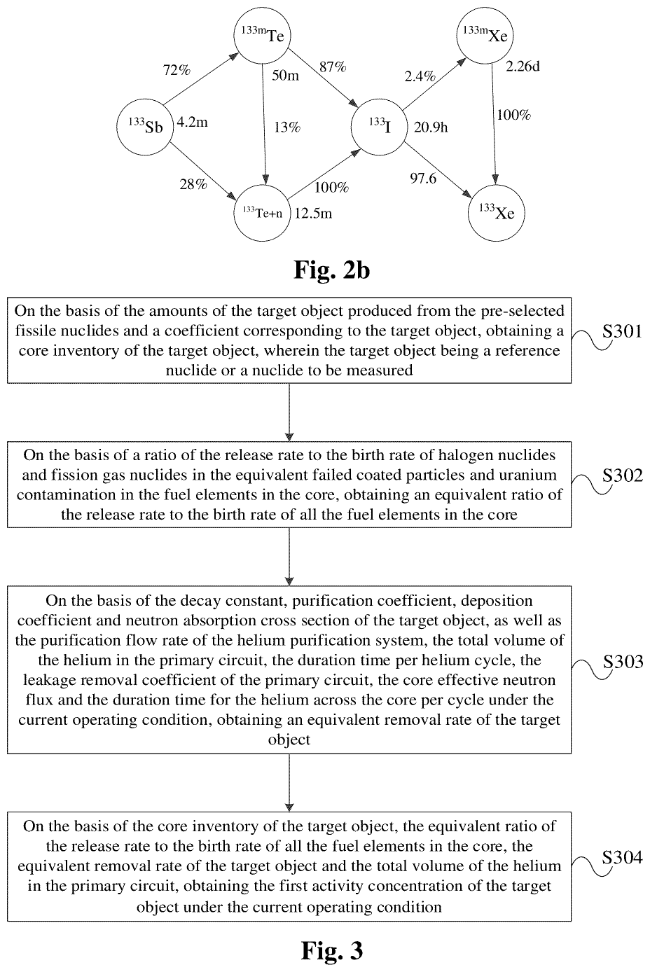

According to decay chain mode A in FIG. 2a, when the nuclide is determined, the decay chain of ^{133m}Xe and ¹³³Xe can be obtained, as shown in FIG. 2b.

Based on FIG. 2a, FIG. 2b and Eq. (1), the analytical solution of the core inventory of ¹³³Xe is:

$${I}_{01} = ( {A}_{f , 1} + {A}_{f , 21} + {A}_{f , 22} + {A}_{f , 3} + {A}_{f , 02} + {A}_{f , 01} ) \frac{{λ}_{01}}{{λ}_{01} + {σ}_{a ,} {ϕ}_{2}}$$

Where I₀₁ is the core inventory of ¹³³Xe, A_{f,1} is the amount of ¹³³Sb which denoted as number 1 in the decay chain of ¹³³Xe, A_{f,21} is the amount of ¹³³Te which denoted as number 2 in the decay chain of ¹³³Xe, A_{f,22} is the amount of ^{133m}Te which denoted as number 22 in the decay chain of ¹³³Xe, A_{f,3} is the amount of ¹³³I which denoted as number 3 in the decay chain of ¹³³Xe, A_{f,02} is the amount of ^{133m}Xe which denoted as number 02 in the decay chain of ¹³³Xe, A_{f,01} is the amount of ¹³³Xe which denoted as number 01 in the decay chain of ¹³³Xe, the coefficients associated with A_{f,1} of ¹³³Sb in the decay chain of ¹³³Xe, A_{f,21} of ¹³³Te in the decay chain of ¹³³Xe, A_{f,22} of ^{133m}Te in the decay chain of ¹³³Xe, A_{f,3} of ¹³³I in the decay chain of ¹³³Xe, A_{f,02} of ^{133m}Xe in the decay chain of ¹³³Xe and A_{f,01} of ¹³³Xe in the decay chain of ¹³³Xe are all the same, which is

$$\frac{{λ}_{01}}{{λ}_{01} + {σ}_{a , 01} {ϕ}_{2}} ,$$

λ₀₁ is the decay constant of ¹³³Xe, φ₂ is equivalent neutron flux in the core, σ_{a,01} is the spectrally averaged neutron absorption cross section of ¹³³Xe. The reactor characteristic parameters include the equivalent neutron flux in the core φ₂ and the number of atoms of the fissile nuclides ²³⁵U, ²³⁸U, ²³⁹Pu and ²⁴¹Pu, denoted as N_{U5}, N_{U8}, N_{Pu9} and N_{Pu1}. The reactor operating parameters include the reduced reactor power P_{final} in the final stage and the average burnup B of fuel elements in the core in actual operation. An arbitrary P_{final} can be selected as the reference power P_{ref}. Based on the equivalent neutron flux φ₂ in the core and the average burnup B of different fuel elements at the reference reduced reactor power P_{ref} in the final stage power, the values of sub-parameters a_{φ}, b_{φ} and c_{φ} can be obtained by fitting. Using the operating condition parameters P_{final}, B and P_{ref}, the equivalent neutron flux φ₂ in the core can be evaluated according to the following formula:

$${ϕ}_{2} = ( {a}_{ϕ} {B}^{2} + {b}_{ϕ} B + {c}_{ϕ} ) \cdot \frac{{P}_{final}}{{P}_{r e f}} \qquad ( 3 )$$

Based on the number of atoms of the fissile nuclides ²³⁵U, ²³⁸U, ²³⁹Pu and ²⁴¹Pu, denoted as N_{U5}, N_{U8}, N_{Pu9} and N_{Pu1}, together with the average burnup B of the fuel elements, the sub-parameters aᵢ, bᵢ and cᵢ for the number of atoms of the fissile nuclides can be obtained by fitting. With the operating parameter B, the number of atoms Nⱼ of the fissile nuclide j can be calculated using the following formula:

$${N}_{j} = ( {a}_{j} {B}^{2} + {b}_{j} B + {c}_{j} ) \qquad ( 4 )$$

where j=U5, U8, Pu9, and Pu1.

For the ratio of the release rate to the birth rate, the release of halogen nuclides and fission gas nuclides originates from three sources: intact coated particles, failed coated particles, and uranium contamination in the matrix graphite. Considering that the diffusion coefficient of fission gas nuclides in the SiC coating layer is extremely small and their half-lives are relatively short, the diffusion of fission gas nuclides through intact coated particles can be neglected. Meanwhile, both the failed coated particles and the uranium contamination in the matrix graphite can be described by the equivalent sphere. Furthermore, because the half-lives of the fission gas nuclides are short (compared with their diffusion times within the fuel kernel), the time required to reach equilibrium can be ignored, and the diffusion equation can be solved under the steady-state condition. In this application, the total amount of halogen nuclides and fission gas nuclides generated and subsequently released from the fuel elements into the primary circuit is considered to consist of three parts: failed coated particles, matrix graphite grains, and amorphous carbon. Due to the presence of the SiC layer, the intact coated particles exhibit very strong retention capability for halogen nuclides and fission gas nuclides, and are therefore assumed to fully retain these nuclides. The UO₂ particles resulting from the uranium contamination in the matrix graphite during the process are accounted for equivalently in the aforementioned three parts.

The equivalent ratio of the release rate to the birth rate in all the fuel elements in the core,

$$\frac{R}{B} {\vert}_{total} ,$$

is given by:

$$\frac{R}{B} {\vert}_{total} = \frac{R}{B} {\vert}_{failure} + \frac{R}{B} {\vert}_{contamination} = F \frac{R}{B} {\vert}_{k e r n e l} + C \frac{R}{B} {\vert}_{nature} \qquad ( 5 )$$

$$\frac{R}{B} {\vert}_{nature} = 0.9998 ( 0.995 \frac{R}{B} {\vert}_{g r a i n} + 0.005 \frac{R}{B} {\vert}_{amorphas} ) + 0.0002 \qquad ( 6 )$$

Where, F is the failure fraction of coated particles in the fuel elements in an HTGR, and C is the share of uranium contamination in the matrix graphite in the core,

$$\frac{R}{B} {\vert}_{f a i l u r e} and \frac{R}{B} {\vert}_{contamination}$$

respectively is the ratio of the release rate to the birth rate of halogen nuclides and fission gas nuclides in the equivalent failed coated particles and uranium contamination in the fuel elements in the core,

$$\frac{R}{B} {\vert}_{k e rnel} and \frac{R}{B} {\vert}_{nature}$$

respectively is the ratio of the release rate to the birth rate of halogen nuclides and fission gas nuclides in the equivalent sphere of an individual failed coated particles and in the equivalent sphere of uranium contamination, and

$$\frac{R}{B} {\vert}_{g r a i n} and \frac{R}{B} {\vert}_{a m o r p h a s}$$

respectively is the ratio of the release rate to the birth rate of halogen nuclides and short-lived fission gas nuclides in the equivalent sphere of an individual matrix graphite grain and in the equivalent sphere of the UO₂ particle in the amorphous carbon.

The diffusion coefficients of nuclides in different materials vary with temperature. The ratios of the release rate to the birth rate of halogen nuclides and fission gas nuclides for the equivalent failed coated particles and uranium contamination in the fuel elements in the core, for the equivalent sphere of an individual failed coated particles and uranium contamination, and for the equivalent sphere of an individual matrix graphite grain and the UO₂ particle in the amorphous carbon, must be evaluated with the consideration of the temperature distribution of the fuel elements. The results can be directly calculated at the corresponding temperature and then averaged by weighting according to the temperature fractions.

The Booth model is the basis for the equivalent sphere model for short-lived noble gas fission products, and the model can be analytically described as follows:

$$\frac{R}{B} = 3 \sqrt{\frac{D}{{λ}_{eff} {a}^{2}}} ( coth ( \sqrt{\frac{{λ}_{eff} {a}^{2}}{D}} ) - \sqrt{\frac{D}{{λ}_{eff} {a}^{2}}} ) \qquad ( 7 )$$

Where, a is the radius of the equivalent sphere, R/B is the ratio of the release rate to the birth rate of the nuclide, D is the diffusion coefficient of the nuclide, λ_{eff}=λ+σₐφ₁ is the effective decay constant of the nuclide that accounts for both decay and neutron absorption, λ is the decay constant of the nuclide, σₐ is the spectrally averaged neutron absorption cross section of the nuclide, and φ₁ is the core effective neutron flux.

Furthermore, defining D′=D/a² as the reduced diffusion coefficient of the nuclide, can be represented by the Arrhenius formula:

$${D}^{′} = {D}_{0}^{′} {e}^{- Q / ( {R}_{g} T )} \qquad ( 8 )$$

Where,

$${D}_{0}^{′}$$

is the frequency factor, e is natural constant, Q is the activation energy, R_{g} is the ideal gas constant, and T is the temperature of the diffusion material. The diffusion material includes, but is not limited to, UO₂ kernel, the crystalline grains of the matrix graphite, amorphous carbon, etc.

The halogen nuclides and fission gas nuclides released into the primary coolant are transported from the core region to the primary circuit system along with the primary coolant. During reactor operation, these radioactive nuclides undergo decay, purification by the helium purification system, deposition on the surfaces in contact with the primary coolant (while fission gas nuclides are generally assumed not to deposit), leakage in small amounts during the primary circuit circulation, and continuous removal due to neutron absorption when passing through the core (mainly ¹³⁵Xe). After a certain period of time, the production and removal of the nuclides reach a dynamic equilibrium state.

The theoretical activity concentration A (Bq/L) at equilibrium of nuclide in the primary circuit is given by:

$$A = \frac{Re}{V τ} = \frac{{λ}_{eff} I \frac{R}{B} {\vert}_{t o t a l}}{V τ} \qquad ( 9 )$$

$$Re = {λ}_{eff} I \frac{R}{B} {\vert}_{total} \qquad ( 10 )$$

$$τ = λ + ε \frac{Q}{V} + \frac{δ}{{t}_{e}} + ω + {σ}_{a} {ϕ}_{1} \frac{{t}_{v}}{{t}_{c}} \qquad ( 11 )$$

$${λ}_{eff} = λ + {σ}_{a} {ϕ}_{1} \qquad ( 12 )$$

Where, Re is the equivalent release rate of the nuclide from the core, I is core inventory of the nuclide, ε is the purification coefficient of the nuclide, Q is the purification flow rate of the gas purification system, V is the total volume of the helium in the primary circuit, δ is deposition coefficient of the nuclide per cycle, t_{c} is the duration time per helium cycle, ω is the leakage removal coefficient of the primary circuit, σₐ is the spectrally averaged neutron absorption cross section of the nuclide, φ₁ is the core effective neutron flux, tᵥ is the duration time for the helium across the core per cycle, τ is the equivalent removal constant, λ_{eff} is the effective decay constant,

$$\frac{R}{B} {\vert}_{total}$$

is the equivalent ratio of the release rate to the birth rate for all the fuel elements in the core, and λ is the decay constant of the nuclide.

FIG. 3 is a flowchart of a method for measuring the activity concentration in the primary circuit of an HTGR according to the third embodiment of the present invention. As shown in FIG. 3, on the basis of the above-mentioned embodiments, and further, based on the operating parameters under the current operating condition and the calculated parameters corresponding to the target nuclide, the first activity concentration of the target nuclide under the current operating condition can be obtained, comprising:

S301 On the basis of the amounts of the target object produced from the pre-selected fissile nuclides and a coefficient corresponding to the target object, obtaining a core inventory of the target object, wherein the target object being a reference nuclide or a nuclide to be measured;

Specifically, based on the amounts of the target object produced from the pre-selected fission nuclides and the coefficients corresponding to the target object, the core inventory corresponding to the target object can be obtained. The target object is either a reference nuclide or a nuclide to be measured, and the reference object includes the reference nuclide. The amounts of the target object produced from the pre-selected fissile nuclides include the amounts of the nuclides in the decay chain of the target object produced from the pre-selected fission nuclides. If the target object is a reference nuclide, the core inventory of the reference nuclide can be obtained based on equation (1). The coefficient corresponding to the reference nuclide is the coefficient of A_{f,i,k} of nuclide k in the decay chain of the reference nuclide. Once the reference nuclide is determined, the coefficient corresponding to the reference nuclide is also fixed and can be obtained through calculation. The amount of the nuclide k in the decay chain of the reference nuclide produced by the pre-selected fission nuclides can be calculated based on equation (2).

For example, based on equation (1), the core inventory of the reference nuclide can be calculated as:

$${I}_{r e f} = {\sum }_{k} {c}_{k , r e f} {A}_{f , r e f , k}$$

where I_{ref} is the core inventory corresponding to the reference nuclide ref, c_{k,ref} is the coefficient corresponding to the reference nuclide ref, and A_{f,ref,k} is the amount of the nuclide k produced from the pre-selected fissile nuclides, and k is the different nuclide designation in the decay chain of the reference nuclide ref.

If the target object is a nuclide to be measured, its core inventory can be calculated using equation (1). The coefficient corresponding to the nuclide to be measured is the coefficient of A_{f,i,k} of nuclide k in the decay chain of the nuclide to be measured. Once the nuclide to be measured is determined, the coefficient corresponding to the nuclide to be measured is also fixed and can be obtained through calculation. The amount of the nuclide k in the decay chain of the nuclide to be measured that produced from the pre-selected fission nuclides can be calculated based on equation (2).

For example, based on equation (1), the core inventory of the nuclide to be measured can be calculated as:

$${I}_{d} = {\sum }_{k} {c}_{k , d} {A}_{f , d , k}$$

Where I_{d} is the core inventory corresponding to the nuclide d to be measured, c_{k,d} is the coefficient corresponding to the nuclide d to be measured, and A_{f,d,k} is the amount of the nuclide k produced from the pre-selected fissile nuclides, and k is the different nuclide designation in the decay chain of the nuclide d to be measured.

S302 On the basis of a ratio of the release rate to the birth rate of halogen nuclides and fission gas nuclides in the equivalent failed coated particles and uranium contamination in the fuel elements in the core, obtaining an equivalent ratio of the release rate to the birth rate of all the fuel elements in the core;

Specifically, the sum of the ratio of the release rate to the birth rate of halogen nuclides and fission gas nuclides in the equivalent failed coated particles in the fuel elements in the core, denoted as

$$\frac{R}{B} {\vert}_{failure} ,$$

and the ratio of the release rate to birth rate of halogen nuclides and fission gas nuclides in the equivalent uranium contamination in the fuel elements in the core, denoted as

$$\frac{R}{B} {\vert}_{contamination} ,$$

is taken as the equivalent ratio of the release rate to the birth rate of all the fuel elements in the core.

Wherein, the ratio of the release rate to the birth rate of halogen nuclides and fission gases nuclides in the equivalent failed coated particles of the fuel elements in the core can be obtained by calculating the product of the failure fraction of coated particles in the fuel elements in HTGR and the ratio of the release rate to birth rate of halogen nuclides and fission gases nuclides in the equivalent sphere of an individual failed coated particle. The ratio of the release rate to birth rate of halogen nuclides and fission gases nuclides in the equivalent uranium contamination in the fuel elements in the core can be obtained by calculating the product of the share of uranium contamination in the matrix graphite of the fuel elements and the ratio of the release rate to birth rate of halogen nuclides and fission gas nuclides in the equivalent sphere of uranium contamination. The ratio of the release rate to birth rate in the equivalent sphere of uranium contamination can be obtained based on equation (6).

S303 On the basis of the decay constant, purification coefficient, deposition coefficient and neutron absorption cross section of the target object, as well as the purification flow rate of the helium purification system, the total volume of the helium in the primary circuit, the duration time per helium cycle, the leakage removal coefficient of the primary circuit, the core effective neutron flux and the duration time for the helium across the core per cycle under the current operating condition, obtaining an equivalent removal rate of the target object;

Specifically, the decay constant of the target object, the purification coefficient of the target object, the deposition coefficient of the target object, and the neutron absorption cross section of the target object are related to the target nuclide itself, and the relevant information can be obtained by querying based on the target object. The purification flow rate of the helium purification system, the total volume of the helium in the primary circuit, the duration time per helium cycle, the leakage removal coefficient of the primary circuit, the core effective neutron flux and the duration time for the helium across the core per cycle are related to the current operating condition and can be determined according to the current operating condition. According to the decay constant, the purification coefficient, the deposition coefficient and the neutron absorption cross section of the target object, together with the purification flow rate of the helium purification system, the total volume of the helium in the primary circuit, the duration time per helium cycle, the leakage removal coefficient of the primary circuit, the core effective neutron flux and the duration time for the helium across the core per cycle under the current operating condition, the equivalent removal rate of the target object can be obtained.

For example, if the target object is a reference nuclide, the equivalent removal rate of the reference nuclide can be calculated according to equation (11), and its calculation formula is as follows:

$${τ}_{r e f} = {λ}_{r e f} + {ε}_{r e f} \frac{Q}{V} + \frac{{δ}_{r e f}}{{t}_{c}} + ω + {σ}_{a , r e f} {ϕ}_{1} \frac{{t}_{v}}{{t}_{c}}$$

Where τ_{ref} is the equivalent removal rate of the reference nuclide, λ_{ref} is the decay constant of the reference nuclide, ε_{ref} is the purification coefficient of the reference nuclide, δ_{ref} is the deposition coefficient of the reference nuclide, σ_{a,ref} is the spectrally averaged neutron absorption cross section of the reference nuclide, Q is the purification flow rate of the helium purification system, V is the total volume of the helium in the primary circuit, t_{c} is the duration time per helium cycle, ω is the leakage removal coefficient of the primary circuit, φ₁ is the core effective neutron flux, and tᵥ is the duration time for the helium across the core per cycle.

For example, when the target object is a nuclide to be measured, the equivalent removal rate of the nuclide to be measured is obtained according to equation (11), and its calculation formula is as follows:

$${τ}_{d} = {λ}_{d} + {ε}_{d} \frac{Q}{V} + \frac{{δ}_{d}}{{t}_{c}} + ω + {σ}_{a . d} {ϕ}_{1} \frac{{t}_{v}}{{t}_{c}}$$

Where τ_{d} is the equivalent removal rate of the nuclide to be measured, λ_{d} is the decay constant of the nuclide to be measured, ε_{d} is the purification coefficient of the nuclide to be measured, δ_{d} is the deposition coefficient of the nuclide to be measured, σ_{a.d} is the spectrally averaged neutron absorption cross section of the nuclide to be measured, Q is the purification flow rate of the helium purification system, V is the total volume of the helium in the primary circuit, t_{c} is the duration time per helium cycle, ω is the leakage removal coefficient of the primary circuit, φ₁ is the core effective neutron flux, and tᵥ is the duration time for the helium across the core per cycle.

S304 On the basis of the core inventory of the target object, the equivalent ratio of the release rate to the birth rate of all the fuel elements in the core, the equivalent removal rate of the target object and the total volume of the helium in the primary circuit, obtaining the first activity concentration of the target object under the current operating condition.

Specifically, after obtaining the core inventory of the target object, the equivalent ratio of the release rate to birth rate of all the fuel elements in the core and the equivalent removal rate of the target object, the first activity concentration of the target object under the current operating condition can be obtained based on the core inventory of the target object, the equivalent ratio of the release rate to birth rate of all the fuel elements in the core, the equivalent removal rate of the target object and the total volume of the helium in the primary circuit.

On the basis of the above-mentioned embodiments, further, obtaining the first activity concentration of the target object under the current operating condition based on the core inventory of the target object, the equivalent ratio of the release rate to the birth rate of all the fuel elements in the core, the equivalent removal rate of the target object and the total volume of the helium in the primary circuit, comprising:

According to equation

$${A}_{r e f} = \frac{{λ}_{e f f} I \frac{R}{B} {\vert}_{t o t a l}}{V τ} ,$$

the first activity concentration of the target object under the current operating condition A_{ref} is calculated, where λ_{eff} is the effective decay constant, I denotes the core inventory of the target object,

$$\frac{R}{B} {\vert}_{total}$$

is the equivalent ratio of the release rate to the birth rate of all the fuel elements in the core, τ is the equivalent removal rate of the target object, V iss the total volume of the helium in the primary circuit, λ_{eff}=λ+σₐφ₁, λ is the decay constant of the target object, σₐ is the spectrally averaged neutron absorption cross section of the target object, and φ₁ is the core effective neutron flux.

Specifically, after calculating the effective decay constant λ_{eff} through λ_{eff}λ+σₐφ₁, the obtained effective decay constant λ_{eff}, the core inventory I of the target object, the equivalent ratio of the release rate to the birth rate

$$\frac{R}{B} {\vert}_{total}$$

of all the fuel elements in the core, and the equivalent removal rate T of the target object are substituted into equation

$${A}_{r e f} = \frac{{λ}_{e f f} I \frac{R}{B} {\vert}_{t o t a l}}{V τ} ,$$

so that the first activity concentration A_{ref} of the target object under the current operating condition can be calculated.

On the basis of the above-mentioned embodiments, further, obtaining the equivalent removal rate of the target object according to the decay constant, the purification coefficient, the deposition coefficient and the neutron absorption cross section of the target object, as well as the purification flow rate of the helium purification system, the total volume of the helium in the primary circuit, the duration time per helium cycle, the leakage removal coefficient of the primary circuit, the core effective neutron flux, and the duration time for the helium across the core per cycle under the current operating condition, comprising:

According to equation

$$τ = λ + ε \frac{Q}{V} + \frac{δ}{{t}_{c}} + ω + {σ}_{a} {ϕ}_{1} \frac{{t}_{v}}{{t}_{c}} ,$$

the equivalent removal rate τ of the target object is calculated, where λ is the decay constant of the target object, ε is the purification coefficient of the target object, Q is the purification flow rate of the helium purification system, V is the total volume of the helium in the primary circuit, δ is the deposition coefficient of the target object, t_{c} is the duration time per helium cycle, ω is the leakage removal coefficient of the primary circuit, σₐ is the neutron absorption cross section of the target object, φ₁ is the core effective neutron flux, and tᵥ is the duration time for the helium across the core per cycle.

On the basis of the above-mentioned embodiments, further, obtaining the equivalent ratio of the release rate to the birth rate of all the fuel elements in the core according to the ratio of the release rate to the birth rate of halogen nuclides and fission gas nuclides in the equivalent failed coated particles and in the equivalent uranium contamination in the fuel elements in the core, comprising:

According to equation

$$\frac{R}{B} {\vert}_{total} = F \frac{R}{B} {\vert}_{k e r n e l} + C \frac{R}{B} {\vert}_{nature} ,$$

the equivalent ratio of the release rate to the birth rate of all the fuel elements in the core,

$$\frac{R}{B} {\vert}_{total}$$

is obtained, where F is the failure fraction of coated particles in the fuel elements in an HTGR, C is the share of uranium contamination in the matrix graphite in the core,

$$\frac{R}{B} {\vert}_{k e r n e l}$$

is the ratio of the release rate to the birth rate of halogen nuclides and fission gas nuclides in the equivalent sphere of an individual failed coated particle, and

$$\frac{R}{B} {\vert}_{nature}$$

is the ratio of the release rate to the birth rate of halogen nuclides and fission gas nuclides in the equivalent sphere of uranium contamination.

On the basis of the above-mentioned embodiments, further, obtaining the core inventory of the target object according to the amounts of the nuclides in the decay chain of the target object produced from the pre-selected fissile nuclides and the corresponding coefficient of the target object, comprising:

According to equation Iᵢ=ΣₖcₖA_{f,i,k}, the core inventory Iᵢ of the nuclide i is obtained, where A_{f,i,k} is the amount of the nuclide k produced from the pre-selected fissile nuclides, cₖ is the coefficient of A_{f,i,k} of the nuclide k in the decay chain of the nuclide i, and k is the different nuclide designation in the decay chain of the nuclide i.

On the basis of the above-mentioned embodiments, further, when the reference object is a fission-gas nuclide set, the process of obtaining the first activity concentration of the fission-gas nuclide set under the current operating condition, based on the operating parameters corresponding to the current operating condition and the calculation parameters of fission-gas nuclide set, comprising:

Based on the operating parameters corresponding to the current operating condition and the calculation parameters of each nuclide in the fission-gas nuclide set, the first activity concentration of each nuclide in the fission-gas nuclide set under the current operating condition is calculated.

To obtain the first activity concentration of fission-gas nuclide set under the current operating condition, the first activity concentration of each nuclide in the fission-gas nuclide set under the current operating condition is summed.

Specifically, the fission-gas nuclide set consists of multiple nuclides. For each nuclide in the fission-gas nuclide set, the first activity concentration of each nuclide in the fission-gas nuclide set under the current operating condition can be calculated from the operating parameters corresponding to the current operating condition and the calculation parameters of that nuclide. The detailed calculation of the first activity concentration of each nuclide in the fission-gas nuclide set is analogous to the calculation process of the first activity concentration of a reference nuclide under the current operating condition, and is therefore not repeated here.

After obtaining the first activity concentration of each nuclide in the fission-gas nuclide set, the first activity concentrations of all nuclides in the fission-gas nuclide set under the current operating condition are summed, which is taken as the first activity concentration of the fission-gas nuclide set under the current operating condition.

For example, if the first activity concentration of the p-th nuclide in the fission-gas nuclide set under the current operating condition is Aₚ, the first activity concentration of the fission-gas nuclide set under the current operating condition is

$${A}_{tot} = {\sum }_{p = 1}^{z} {A}_{p} ,$$

where p is a positive integer and p≤z, and z is the total number of nuclides included in the fission-gas nuclide set.

On the basis of the above-mentioned embodiments, further, obtaining the second activity concentration of the nuclide to be measured under the current operating condition, according to the first activity concentration of the nuclide to be measured under the current operating condition, the first activity concentration of the reference object under the current operating condition and the second activity concentration of the reference object under the current operating condition, comprising:

According to equation

$${a}_{r , j} = \frac{{A}_{j}}{{A}_{ref}} {a}_{ref} ,$$

the second activity concentration a_{r,j} of the nuclide to be measured under the current operating condition is obtained, where Aⱼ is the first activity concentration of the nuclide to be measured under the current operating condition, A_{ref} is the first activity concentration of the reference object under the current operating condition, and a_{ref} is the second activity concentration of the reference object under the current operating condition.

Specifically, once the first activity concentration Aⱼ of the nuclide to be measured under the current operating condition, the first activity concentration A_{ref} of the reference object under the current operating condition and the second activity concentration a_{ref} of the reference object under the current operating condition have been obtained, the second activity concentration a_{r,j} of the nuclide to be measured under the current operating condition can be calculated directly from equation

$${a}_{r , j} = \frac{{A}_{j}}{{A}_{ref}} {a}_{ref} .$$

### Equation

$${a}_{r , j} = \frac{{A}_{j}}{{A}_{ref}} {a}_{ref}$$

indicates that, after experimentally determining the activity concentration of short-lived nuclides in the primary circuit or the total activity concentration of important fission gas nuclides in the primary circuit, the activity concentration of other short-lived fission gas nuclides and halogen nuclides in the primary circuit can be obtained reasonably and accurately by ratio method.

When the second activity concentration of the reference object under the current operating condition is obtained through experimental measurement of activity concentration in the primary circuit, if the measuring equipment has sufficiently high accuracy so that the second activity concentration of the reference nuclide under the current operating condition can be obtained, then the second activity concentration of the nuclide to be measured under the current operating condition is calculated using the first activity concentration of the reference nuclide under the current operating condition together with the second activity concentration of the reference nuclide under the current operating condition. If the measuring equipment can't provide the first activity concentration of the reference nuclide under the current operating condition, then the first activity concentration of the fission-gas nuclide set under the current operating condition and the second activity concentration of the fission-gas nuclide set under the current operating condition are used to calculate the second activity concentration of the nuclide to be measured under the current operating condition.

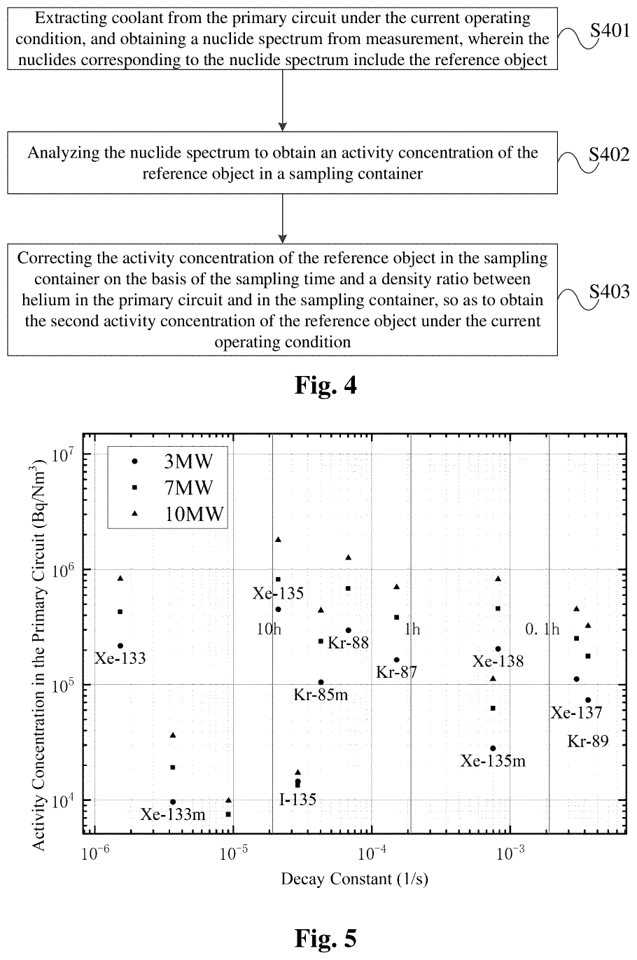

FIG. 4 is a flowchart of a method for measuring the activity concentration in the primary circuit of an HTGR according to the fourth embodiment of the present invention. As shown in FIG. 4, based on the foregoing embodiments, obtaining the second activity concentration of the reference object under the current operating condition through experimental measurement of the activity concentration in the primary circuit, comprising:

S401. Extracting coolant from the primary circuit under the current operating condition, and obtaining a nuclide spectrum from measurement, wherein the nuclides corresponding to the nuclide spectrum include the reference object;

Specifically, the primary circuit activity concentration measurement adopts a sampling type online monitoring method. The primary helium coolant containing radioactive nuclides passes through the copper-oxide bed and then enters the sampling vessel through the inlet line of the sampling system. After sampling and measurement, the primary helium coolant is discharged through the exhaust line and treated by the ventilation system. After the reactor has operated at a set power for a period of time under steady conditions, a little of coolant is extracted from the primary circuit and the nuclide spectrum is measured. The nuclide spectrum contains the reference nuclide. The set power is selected according to practical experience and is not limited by the present invention. The spectrum may be a γ spectrum, an X spectrum, or another type of spectrum selected according to actual needs. The present embodiment of the invention is not limited thereto.

S402. Analyzing the nuclide spectrum to obtain an activity concentration of the reference object in a sampling container;

Specifically, the nuclide spectrum obtained from the primary circuit is analyzed to identify the reference object in the sampling container, and then the activity concentration of the reference object in the sampling container is calculated.

When the reference object is a reference nuclide, analyzing the γ spectrum of the nuclides includes energy calibration, efficiency calibration and nuclide identification of the γ spectrum. Each nuclide has characteristic γ-ray energies, which can be used to distinguish nuclides. During energy calibration, the peak energies identified in the γ spectrum are compared with the known peak-energy data of nuclides stored in a nuclide database to distinguish nuclides. The nuclide database is obtained in advance and contains known peak-energy data of nuclides. For example, the nuclide database can be the built-in nuclear database in the professional γ-spectrum analysis software or the IAEA nuclear database.

The peak energy data corresponding to the known nuclides include the range of the peak energy values. If the peak energy identified in the γ spectrum falls within the range of peak energy values corresponding to a certain known nuclide, it can be determined which nuclide corresponds to the peak energy identified in the nuclide γ spectrum. Since, in some cases, peak energies of different nuclides in the γ spectrum may be very close to one another and fall within the same allowable peak-energy range of a known nuclide, it is necessary to compare peak energies over the entire energy range of the γ spectrum. In addition, consider the nuclides that may be present in the sampling container in order to make a further identification. For nuclide energy calibration, ⁸⁸Kr can be selected as the calibration nuclide, because the concentration of ⁸⁸Kr in the primary coolant is usually sufficiently high; moreover, ⁸⁸Kr exhibits a sufficient number of characteristic γ-ray peaks with relatively high intensities, and these peaks can cover the measurement range of an HPGe detector (3-3000 keV).

After the reference nuclide in the γ spectrum has been identified, the activity concentration of the reference nuclide in the sampling container is calculated from the net peak area of the corresponding spectral peak:

$${a}_{ref} = \frac{{C}_{net , ref}}{{I}_{γ} ϵ tV} \cdot {f}_{1}$$

Where a_{ref} is the activity concentration of the reference nuclide in the sampling container, C_{net,ref} is the net peak area of the spectral peak of the reference nuclide, equal to the gross peak area minus the background, I_{γ} is the emission probability of the energy peak of the reference nuclide, t is the measurement time of the spectrum of the sample, V is the sample volume, ϵ is the detection efficiency of the detector, f₁ is the measurement time correction factor accounting for the self decay of the radioactive nuclide during the measurement by the detector. The detection efficiency ϵ can be obtained through efficiency calibration using the nuclide γ spectra.

The measurement time correction factor f₁ can be calculated from equation

$${f}_{1} = \frac{{λ}_{ref} t}{1 - {e}^{- {λ}_{ref}}} ,$$

where λ_{ref} is the decay constant of the reference nuclide.

Since multiple energy peaks may exist for the reference nuclide, the following method is adopted to improve reliability: 1) Only the net peak areas whose uncertainties are below a specified threshold are used for calculating the activity concentration of the reference nuclide; 2) The activity concentration of the reference nuclide is taken as the weighted average of the activity concentrations obtained from the energy peaks that satisfy condition 1), where the weight corresponding to the energy peak is obtained by normalizing the reciprocal of the square of the uncertainty of the activity concentration calculated based on each energy peak. The threshold is determined based on practical experience and is not limited by the present invention; for example, a threshold value of 12% may be used.

Therefore, substituting equation

$${a}_{ref} = \frac{{C}_{net , ref}}{{I}_{γ} ϵ tV} \cdot {f}_{1}$$

yields

$${a}_{r e f} = {\sum }_{β = 1}^{m} {w}_{β} {a}_{ref}^{β} ,$$

$${a}_{ref}^{β} = \frac{{C}_{net , ref}^{β}}{{I}_{γ}^{β} ϵ tV} \cdot {f}_{1} , where {a}_{ref}^{β}$$

is the activity concentration corresponding to the β-th energy peak of the reference nuclide, w_{β} is the weight factor corresponding to

$${a}_{ref}^{β} , {C}_{net , ref}^{β}$$

is the net peak area of the β-th energy peak of the reference nuclide,

$${I}_{γ}^{β}$$

is the emission probability of the β-th energy peak of the reference nuclide, ϵ is the detection efficiency of the detector, t is the measurement time of the spectrum of the sample, V is the sample volume, f₁ is the measurement time correction factor accounting for the self decay of the radioactive nuclide during the measurement by the detector, and m is the total number of energy peaks corresponding to the reference nuclide.

When the reference object is the fission-gas nuclide set, analysis of the γ-spectrum of the fission-gas nuclide set includes energy calibration and efficiency calibration of the γ-spectrum of the fission-gas nuclide set. The γ-rays emitted by the fission-gas nuclide set have characteristic energies. During nuclide energy calibration, the peak energies identified in the spectrum of the fission-gas nuclide set are used.

For nuclide energy calibration, ⁸⁸Kr can be selected as the calibration nuclide because its concentration in the primary coolant is usually sufficiently high. ⁸⁸Kr provides multiple γ-ray peaks with relatively high intensities, and these peaks cover the measurement range of an HPGe detector (3-3000 keV).

The activity concentration of the fission-gas nuclide set in the sampling container is determined from the net peak areas of the spectral peaks:

$${a}_{c} = \frac{{C}_{net , c}}{ϵ tV}$$

Where a_{c} is the activity concentration of the fission-gas nuclide set in the sampling container, C_{net,c} is the net peak area of the spectral peak of the fission-gas nuclide set, equal to the gross peak area minus the background, t the measurement time of the spectrum of the sample, V is the sample volume, and ϵ is the detection efficiency of the detector. The detection efficiency ϵ can be obtained through efficiency calibration using the nuclide γ spectra of the fission-gas nuclide set.

Since multiple energy peaks may exist for the fission-gas nuclide set, the following method is adopted to improve reliability: 1) Only net peak areas whose uncertainties are below a specified threshold are used for calculating the activity concentration of the fission-gas nuclide set; 2) The activity concentration of the fission-gas nuclide set is taken as the weighted average of the activity concentrations obtained from the energy peaks that satisfy condition 1), where the weight corresponding to the energy peak is obtained by normalizing the reciprocal of the square of the uncertainty of the activity concentration calculated based on each energy peak. he threshold is determined based on practical experience and is not limited by the present invention; for example, a threshold value of 12% may be used.

Therefore, change equation

$${a}_{c} = \frac{{C}_{n e t , c}}{ϵ tV} to {a}_{c} = {\sum }_{θ = 1}^{m} {w}_{θ} {a}_{c}^{θ} , {a}_{c}^{β} = \frac{{C}_{n e t , c}^{θ}}{ϵ tV} , where {a}_{c}^{θ}$$

is the activity concentration corresponding to the θ-th energy peak of the fission-gas nuclide set, w_{θ} is the weight factor corresponding to

$${a}_{c}^{θ} ,$$

C_{net,c} is the net peak area of the θ-th energy peak of the fission-gas nuclide set, ϵ is the detector efficiency of the detector, t is the measurement time of the spectrum of the sample, V is the sample volume, and n is the total number of energy peaks corresponding to the fission-gas nuclide set.

S403. Correcting the activity concentration of the reference object in the sampling container on the basis of the sampling time and a density ratio between helium in the primary circuit and in the sampling container, so as to obtain the second activity concentration of the reference object under the current operating condition.

Specifically, the helium coolant enters the sampling container from the primary circuit through a section of the primary circuit piping, including part of the helium purification system and the gas-sampling line, which requires a certain amount of time. Filling the sampling container with the sampled gas also requires a certain amount of time. These two periods together constitute the sampling time. The sampling time, as well as the helium densities in the primary circuit and in the sampling container, affect the activity concentration of the reference object measured in the sampling container. Therefore, by correcting the measured activity concentration of the reference object using the sampling time and the density ratio of helium between the primary circuit and the sampling container, the second activity concentration of the reference object under the current operating condition can be obtained. The sampling time may be selected according to actual requirements and is not limited by the present invention.

The activity concentration of the reference object measured in the sampling container can be corrected using a_{pc}=a·f₂·f₃ to obtain the first activity concentration a_{pc} of the reference object under the current operating condition, where f₂ is the sampling time correction factor, f₃ is the density correction factor,

$${f}_{2} = {e}^{λ {t}_{s}} , {f}_{3} = \frac{{ρ}_{p c} ( P , T )}{{ρ}_{S} ( P , T )} ,$$

λ is the decay constant of the reference object, tₛ is the sampling time, ρ_{pc}(P,T) is the average helium density in the primary circuit under pressure P and temperature T, and ρₛ(P,T) is the average helium density in the sampling container under the same pressure P and temperature T.

A specific implementation example is provided below to illustrate the application of the method for measuring the activity concentration in the primary circuit of an HTGR according to the embodiments of the present invention.

For HTR-10, measurements of the primary circuit activity concentration were performed under three operating conditions corresponding to reactor power levels of 3, 7 and 10 MW. The fission gas nuclides in the HTR-10 primary circuit were classified into four groups according to their half-lives, arranged from long to short: Group 1, Group 2, Group 3 and Group 4. The boundaries between the groups were selected as 10, 1 and 0.1 hours. Group 1 contains the nuclides ¹³³Xe and ^{133m}Xe, with half-lives of 5.25 and 2.19 days, respectively. Group 2 contains the nuclides ^{85m}Kr, ⁸⁷Kr, ⁸⁸Kr and ¹³⁵Xe, with half-lives of 4.48, 1.27, 2.84 and 9.11 hours, respectively. Group 3 contains ^{135m}Xe and ¹³⁸Xe, with half-lives of 15.36 and 14.13 minutes, respectively. Group 4 contains ⁸⁹Kr and ¹³⁷Xe, with half-lives of 3.16 and 3.83 minutes, respectively.

FIG. 4 presents the experimental measurement values of the activity concentrations of the fission gas nuclides in the HTR-10 primary circuit at reactor power levels of 3, 7 and 10 MW. The activity concentrations of all nuclides were normalized to the average activity concentration under standard conditions (temperature 25° C. and pressure 1 atm), in the unit of Bq/Nm³. The standard volume of the helium in the HTR-10 primary circuit was taken as 1301 Nm³. The results show that, at reactor power levels of 3, 7 and 10 MW, the experimental total activity concentrations of the nuclides in the primary circuit are 3.93×10⁶, 1.47×10⁷ and 2.01×10⁷ Bq/Nm³, respectively. The activity concentrations of all fission gas nuclides ranged from 3.65×10⁴ to 4.82×10⁶ Bq/Nm³. Because ⁸⁹Kr and ¹³⁷Xe have the shortest half-lives (3.83 and 3.16 minutes, respectively), their data are excluded from FIG. 5 to avoid excessive uncertainties. In addition, except the nuclides Group 1 whose experimental activity concentrations in the primary circuit were independent of the reactor power, the experimental activity concentrations of nuclides in Groups 2, 3 and 4 in the primary circuit were strongly correlated with the reactor power, primarily because the nuclides in Group 1 had not reached equilibrium state during the experimental period.

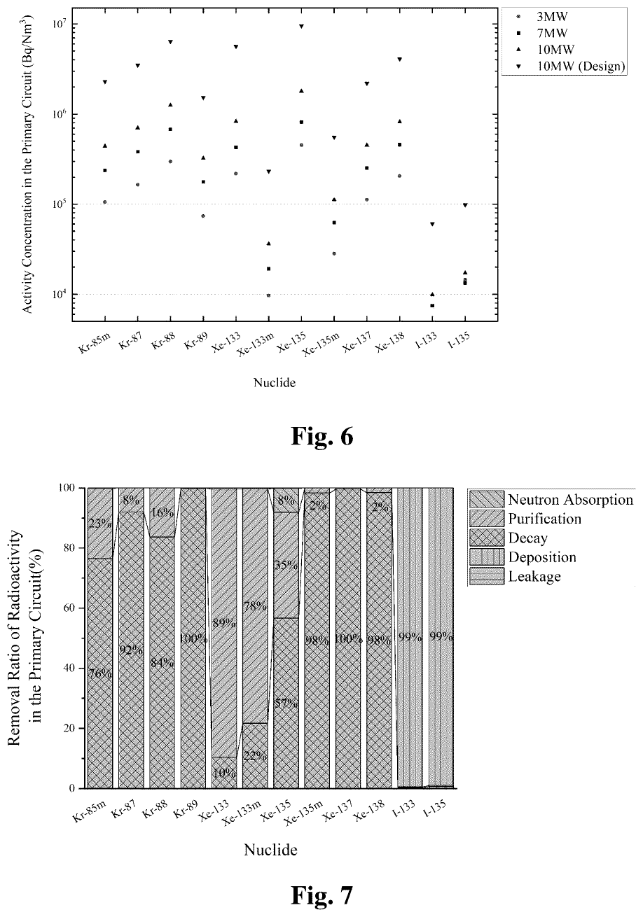

In this application, using the HTR-10 experimental parameters at reactor power levels of 3, 7 and 10 MW, and the corresponding reactor design parameters, the activity concentration of the gaseous fission nuclides in the primary circuit in HTR-10 at equilibrium state under different operating conditions were calculated, as shown in FIG. 6.

FIG. 7 shows the balance diagram of the gaseous fission nuclides in the primary circuit of HTR-10 at a power of 10 MW, and the corresponding situations for other operating powers (3 and 7 MW) are very similar to FIG. 7. In the equilibrium state, the total percentage column in FIG. 7 for each nuclide corresponds to the total amount of that nuclide entered the primary circuit from the fuel elements, and the percentage columns of different filling patterns correspond to the amounts of the nuclides in the primary circuit under different removal pathways. For gaseous fission nuclides, decay and purification are the dominant removal mechanisms. A larger decay constant (shorter half-life) corresponds to a larger fraction of removal by decay and a smaller fraction of removal by purification. In this embodiment, HTR-10 is considered to have reached equilibrium state after operating for a preset period. The preset duration is selected based on practical experience and is not limited in this embodiment. In general, it is chosen to be longer than three times of the half-life of the nuclide to be considered.

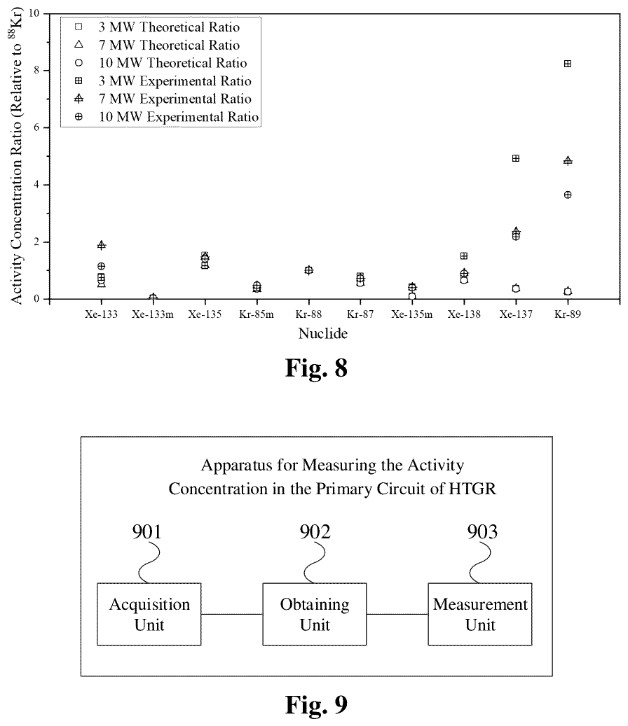

Table 1 provides the ratios from FIG. 8 of the activity concentrations of various radioactive nuclides in the primary circuit to the theoretical calculation of the activity concentration of the reference nuclide ⁸⁸Kr, and also lists the experimental values of the activity concentration of ⁸⁸Kr from FIG. 5. Using equation (9), the activity concentrations of short-lived fission gas nuclides in the primary circuit are obtained by the ratio method. The results indicate that, at reactor power levels of 3, 7 and 10 MW, the experimental values of the total activity concentration of nuclides in the primary circuit of HTR-10 are 1.33×10⁶, 7.01×10⁶ and 1.15×10⁷ Bq/Nm³, respectively, and the activity concentrations of all fission gas nuclides ranged from 6.58×10³ to 1.96×10⁶ Bq/Nm³.

TABLE 1
The activity concentration of short-lived
fission gas nuclides in the primary circuit

| | | The primary circuit activity concentration | | |
|---|---|---|---|---|
| | | (Bq/Nm³) | | |
| Group | Nuclide | 3 MW | 7 MW | 10 MW |
| 1 | ¹³³Xe | 1.49E+05 | 4.42E+05 | 8.56E+05 |
| | ^{133m}Xe | 6.58E+03 | 2.05E+04 | 3.71E+04 |
| 2 | ¹³⁵Xe | 2.94E+05 | 1.01E+06 | 1.90E+06 |
| | ^{85m}Kr | 6.85E+04 | 2.97E+05 | 4.67E+05 |
| | ⁸⁸Kr | 1.93E+05 | 8.54E+05 | 1.33E+06 |
| | ⁸⁷Kr | 1.07E+05 | 4.86E+05 | 7.42E+05 |
| 3 | ^{135m}Xe | 1.82E+04 | 7.77E+04 | 1.18E+05 |
| | ¹³⁸Xe | 1.33E+05 | 5.70E+05 | 8.70E+05 |
| 4 | ¹³⁷Xe | 7.27E+04 | 3.06E+05 | 4.77E+05 |
| | ⁸⁹Kr | 4.76E+04 | 2.31E+05 | 3.42E+05 |
| — | ¹³³I | 5.22E+03 | 1.03E+04 | 1.06E+04 |
| — | ¹³⁵I | 9.90E+03 | 1.97E+04 | 1.86E+04 |
| Total | — | 1.33E+06 | 7.01E+06 | 1.15E+07 |

Because iodine exhibits strong adsorption behavior, a large fraction of iodine is adsorbed on the graphite in the reactor core and on the walls of the piping and equipment in the cold section of the steam generator, making direct sampling and measurement impossible. Consequently, the ratio method can be used as a radiological monitoring scheme for determining the activity concentrations of iodine nuclides in HTGRs under operating conditions.

The theoretical ratios of activity concentration of ¹³³I in the primary circuit to that of ⁸⁸Kr at 3, 7 and 10 MW are 0.027, 0.012 and 0.008, respectively. Using the ratio method, the corresponding activity concentrations of ¹³³I are calculated to be 5.21×10³, 1.02×10⁴ and 1.06×10⁴ Bq/Nm³. For ¹³⁵I, the theoretical ratios of its activity concentration in the primary circuit to that of ⁸⁸Kr at 3, 7 and 10 MW are 0.047, 0.021 and 0.014, respectively, and the activity concentrations obtained using the ratio method are 9.07×10³, 1.80×10⁴ and 1.86×10⁴ Bq/Nm³. The method for measuring the activity concentration in the primary circuit of HTGRs provided in this embodiment is referred to as the ratio method.

The present application establishes a theoretical model for the diffusion and release of gaseous fission products from the fuel elements in the reactor core into the primary circuit, enabling accurate determination of the activity concentrations of gaseous fission products and halogen nuclides in the primary circuit. For the calculation of core inventory, an IPRFGN model is developed, which allows rapid evaluation of the inventories of short-lived iodine and fission gas nuclides and supports accurate and timely determination of the actual core inventory during radiation monitoring. By combining the diffusion and release behavior of nuclides in the fuel elements with the nuclide migration model in the primary circuit, and experimentally determining the parameters F and C, the ratios of the activity concentrations of various nuclides in the primary circuit to that of the reference nuclide in the primary circuit are obtained. Finally, the activity concentrations of gaseous fission products and halogen nuclides in the primary circuit are determined using the ratio method. This invention improves the theoretical framework for radioactive measurements of fission gas nuclides in the primary circuit and provides a solution for iodine experimental measurement, offering important guidance for the radiation safety and protection of HTGRs.

FIG. 9 is a schematic structural diagram of an apparatus for measuring the activity concentration in the primary circuit of an HTGR according to the ninth embodiment of the present invention. As shown in FIG. 9, the apparatus includes an acquisition unit 901, an obtaining unit 902, and a measurement unit 903, where:

Acquisition unit 901 is configured, based on the operating parameters corresponding to the current operating condition and the calculation parameters of the reference object, to determine the first activity concentration of the reference object under the current operating condition. Using the same operating parameters together with the calculation parameters of the nuclide to be measured, the acquisition unit 901 further determines the first activity concentration of the nuclide to be measured under the current operating condition. Obtaining unit 902 is configured to acquire the second activity concentration of the reference object under the current operating condition, wherein the second activity concentration of the reference object under the current operating condition is obtained through experimental measurement of the activity concentration in the primary circuit. Measurement unit 903 is configured to determine the second activity concentration of the nuclide to be measured under the current operating condition, based on the first activity concentration of the nuclide to be measured under the current operating condition, the first activity concentration of the reference object under the current operating condition, and the second activity concentration of the reference object under the current operating condition.

Specifically, based on the theoretical framework and calculation method developed for determining the activity concentrations of radionuclides in the primary circuit of an HTGR, acquisition unit 901 can obtain the theoretical activity concentration of the reference object under the current operating condition on the basis of the operating parameters of the current operating condition and the calculation parameters of the reference object, and take it as the first activity concentration of the reference object under the current operating condition. On the basis of the operating parameters of the current operating condition and the calculation parameters of the nuclide to be measured, acquisition unit 901 can obtain the theoretical activity concentration of the nuclide to be measured under the current operating condition, and take it as its first activity concentration of the nuclide to be measured under the current operating condition.

Obtaining unit 902 can measure the first activity concentration of the reference object under different operating conditions through experiments of activity concentration in the primary circuit. In application, the second activity concentration of the reference object corresponding to the current operating condition can be obtained through lookup.

A computational relationship can be established in advance among the first activity concentration of the nuclide to be measured under the current operating condition, the first activity concentration of the reference object under the current operating condition, the second activity concentration of the reference object under the current operating condition, and the second activity concentration of the nuclide to be measured under the current operating condition. After the measurement unit 903 obtains the first activity concentration of the nuclide to be measured under the current operating condition, the first activity concentration of the reference object under the current operating condition and the second activity concentration of the reference object under the current operating condition, the second activity concentration of the nuclide to be measured under the current operating condition can be obtained by applying the above-mentioned computational relationship.

The measurement apparatus for activity concentration in the primary circuit of an HTGR provided in this embodiment is capable of obtaining the first activity concentration of the reference object under the current operating condition, on the basis of the operating parameters of the current operating condition and the calculation parameters of the reference object, and obtaining the first activity concentration of the nuclide to be measured under the current operating condition, on the basis of the operating parameters of the current operating condition and the calculation parameters of the nuclide to be measured; acquiring the second activity concentration of the reference object under the current operating condition, wherein the second activity concentration of the reference object under the current operating condition is obtained through experimental measurement of the activity concentration in the primary circuit. On the basis of the first activity concentration of the nuclide to be measured under the current operating condition, the first activity concentration of the reference object under the current operating condition and the second activity concentration of the reference object under the current operating condition, the second activity concentration of the nuclide to be measured under the current operating condition can be obtained. This enables accurate measurement of the activity concentrations of short-lived radionuclides, improves the accuracy of measurements of the activity concentration of nuclides in the primary circuit, and allows the measurements of the activity concentrations of halogen nuclides, therefore enhancing the comprehensiveness of measurements of the activity concentration of nuclides in the primary circuit.

FIG. 10 is a schematic structural diagram of an apparatus for measuring the activity concentration in the primary circuit of an HTGR according to the tenth embodiment of the present invention. As shown in FIG. 10, and based on the foregoing embodiments, further, the acquisition unit 901 includes a first acquisition subunit 9011, a second acquisition subunit 9012, a third acquisition subunit 9013 and a fourth acquisition subunit 9014, wherein:

The first acquisition subunit 9011 is configured to obtain the core inventory of the target object, on the basis of the amounts of the target object produced from the pre-selected fissile nuclides and a coefficient corresponding to the target object, wherein the target object is a reference nuclide or a nuclide to be measured. The second acquisition subunit 9012 is configured to obtain the equivalent ratio of the release rate to birth rate for all the fuel elements in the core, on the basis of the ratio of the release rate to birth rate of halogen nuclides and fission gas nuclides in the equivalent failed coated particles and in the equivalent uranium contamination in the fuel elements in the core. The third acquisition subunit 9013 is configured to obtain the equivalent removal rate of the target object, based on the decay constant, the purification coefficient, the deposition coefficient and the neutron absorption cross section of the target object, as well as the purification flow rate of the helium purification system, the total volume of the helium in the primary circuit, the duration time per helium cycle, the leakage removal coefficient of the primary circuit, the core effective neutron flux and the duration time for the helium across the core per cycle under the current operating condition. The fourth acquisition subunit 9014 is configured to obtain the first activity concentration of the target object under the current operating condition, on the basis of the core inventory of the target object, the equivalent ratio of the release rate to birth rate of all the fuel elements in the core, the equivalent removal rate of the target object and the total volume of the helium in the primary circuit.

On the basis of the above-mentioned embodiments, further, the fourth acquisition subunit 9014 is specially configured to:
according to equation

$${A}_{ref} = \frac{{λ}_{eff} I \frac{R}{B} {\vert}_{t o t a l}}{V τ} ,$$

the first activity concentration of the target object under the current operating condition, A_{ref} is calculated, where λ_{eff} is the effective decay constant, I is the core inventory corresponding to the target object,

$$\frac{R}{B} {\vert}_{total}$$

is the equivalent ratio of the release rate to birth rate of all the fuel elements in the core, τ is the equivalent removal rate of the target object, V is the total volume of the helium in the primary circuit, λ_{eff}=λ+σₐφ₁, λ is the decay constant of the target object, σₐ is the neutron absorption cross section of the target object, and φ₁ is the core effective neutron flux.

On the basis of the above-mentioned embodiments, further, the third acquisition subunit 9013 is specially configured to:
according to equation

$$τ = λ + ε \frac{Q}{V} + \frac{δ}{{t}_{c}} + ω + {σ}_{a} {ϕ}_{1} \frac{{t}_{v}}{{t}_{c}} ,$$

the equivalent removal rate τ of the target object is calculated, where λ is the decay constant of the target object, ε is the purification coefficient of the target object, Q is the purification flow rate of the helium purification system, V is the total volume of the helium in the primary circuit, δ is the deposition coefficient of the target object, t_{c} is the duration time per helium cycle, ω is the leakage removal coefficient of the primary circuit, σₐ is the neutron absorption cross section of the target object, φ₁ is the core effective neutron flux, and tᵥ is the duration time for the helium across the core per cycle.

On the basis of the above-mentioned embodiments, further, the second acquisition subunit 9012 is specially configured to:
according to equation

$$\frac{R}{B} {\vert}_{total} = F \frac{R}{B} {\vert}_{k e r n e l} + C \frac{R}{B} {\vert}_{nature} ,$$

the equivalent ratio of the release rate to the birth rate of all the fuel elements in the core

$$\frac{R}{B} {\vert}_{total}$$

is obtained, where F is the failure fraction of coated particles in the fuel elements in an HTGR, C is the share of uranium contamination in the matrix graphite in the core,

$$\frac{R}{B} {\vert}_{k e r n e l}$$

is the ratio of the release rate to the birth rate of halogen nuclides and fission gas nuclides in the equivalent sphere of an individual failed coated particles, and

$$\frac{R}{B} {\vert}_{nature}$$

is the ratio of the release rate to the birth rate of halogen nuclides and fission gas nuclides in the equivalent sphere of uranium contamination.

On the basis of the above-mentioned embodiments, further, the first acquisition subunit 9011 is specially configured to:

According to equation Iᵢ=ΣₖcₖA_{f,i,k}, the core inventory Iᵢ of nuclide i is calculated, where A_{f,i,k} is the amount of nuclide k produced from the pre-selected fissile nuclides, cₖ is the coefficient of A_{f,i,k} of the nuclide k in the decay chain of nuclide i, and k is the different nuclide designation in the decay chain of nuclide i.

On the basis of the above-mentioned embodiments, further, when the reference object is the fission-gas nuclide set, the acquisition unit 901 is specially configured to:
according to the operating parameters of the current operating condition and the calculation parameters of each nuclide in the fission-gas nuclide set, the first activity concentration of each nuclide in the fission-gas nuclide set is calculated; and sum the first activity concentrations of all nuclides in the fission-gas nuclide set, obtaining the first activity concentration of the fission-gas nuclide set under the current operating condition.

On the basis of the above-mentioned embodiments, further, the measurement unit 903 is specially configured to:
according to equation

$${a}_{r , j} = \frac{{A}_{j}}{{A}_{r e f}} {a}_{ref} ,$$

the second activity concentration a_{r,j} of the nuclide to be measured under the current operating condition is obtained, where Aⱼ is the first activity concentration of the nuclide to be measured under the current operating condition, A_{ref} is the first activity concentration of the reference object under the current operating condition, and a_{ref} is the second activity concentration of the reference object under the current operating condition.

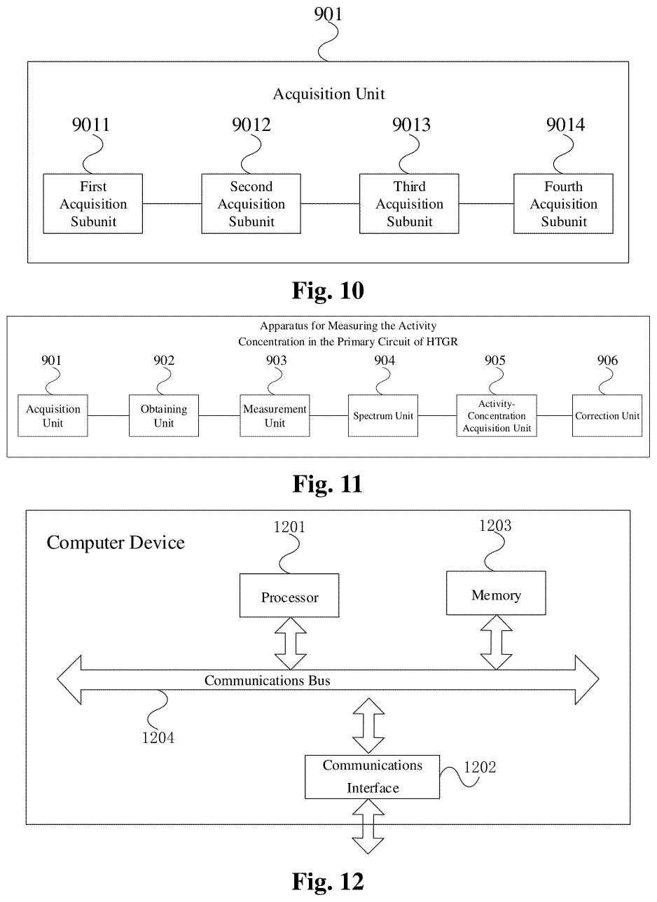

FIG. 11 is a schematic structural diagram of an apparatus for measuring the activity concentration in the primary circuit of an HTGR according to the eleventh embodiment of the present invention. As shown in FIG. 11, On the basis of the above-mentioned embodiments, further, the apparatus for measuring the activity concentration in the primary of an HTGR in the embodiment of present invention, comprises a spectrum unit 904, an activity concentration acquisition unit 905, and a correction unit 906, wherein:

The spectrum unit 904 is configured to extract coolant from the primary circuit under the current operating condition and obtain a nuclide spectrum from measurement, wherein the nuclides corresponding to the nuclide spectrum include the reference object. The activity concentration acquisition unit 905 is configured to analyze the nuclide spectrum to obtain an activity concentration of the reference object in a sampling container. The correction unit 906 is configured to correct the activity concentration of the reference object in the sampling container on the basis of the sampling time and a density ratio between helium in the primary circuit and in the sampling container, so as to obtain the second activity concentration of the reference object under the current operating condition.

The embodiments of the apparatus provided by the present invention can specifically be used to execute the processing procedures of the above-mentioned various method embodiments. Its functions will not be elaborated here and can refer to the detailed descriptions of the above-mentioned implementation examples.

FIG. 12 is a schematic diagram of the physical structure of a computer device according to the twelfth embodiment of the present invention. As shown in FIG. 12, the computer device can include a processor 1201, a communications interface 1202, a memory 1203 and a communications bus 1204. The processor 1201, communications interface 1202, and memory 1203 communicate with each other through the communications bus 1204. The processor 1201 may invoke logic instructions stored in the memory 1203 to implement the methods provided by the above-mentioned embodiments. For example, including: on the basis of the operating parameters of the current operating condition and the calculation parameters of the reference object, obtaining the first activity concentration of the reference object under the current operating condition, and on the basis of the operating parameters of the current operating condition and the calculation parameters of the nuclide to be measured, obtaining the first activity concentration of the nuclide to be measured; obtaining the second activity concentration of the reference object under the current operating condition, wherein the second activity concentration of the reference object is obtained through experimental measurement of the activity concentration in the primary circuit; and, on the basis of the first activity concentration of the nuclide to be measured under the current operating condition, the first activity concentration of the reference object under the current operating condition, and the second activity concentration of the reference object under the current operating condition, obtaining the second activity concentration of the nuclide to be measured under the current operating condition.

Moreover, the logic instructions stored in the aforementioned memory 1203 can be implemented in the form of software functional units and can be sold or used as an independent product. When doing so, they can be stored in a computer-readable storage medium. Based on this understanding, the technical solution of the present invention, which essentially contributes to the existing technology or is part of the technical solution, can be embodied in the form of a computer software product. This computer software product is stored in a storage medium and includes several instructions for enabling a computer device (which can be a personal computer, server, or network device, etc.) to execute all or part of the steps of the methods described in each embodiment of the present invention. The aforementioned storage media include: USB flash drives, portable hard drives, read-only memory (ROM, Read-Only Memory), random access memory (RAM, Random Access Memory), magnetic disks or optical discs, and other various media capable of storing program codes.

The present embodiment discloses a computer program product, wherein it comprises a computer program or instructions. When the computer program or instructions are executed by the processor, it can perform the methods provided by the above-mentioned embodiments, for example including: on the basis of the operating parameters of the current operating condition and the calculation parameters of the reference object, obtaining the first activity concentration of the reference object and on the basis of the operating parameters of the current operating condition and the calculation parameters of the nuclide to be measured, obtaining the first activity concentration of the nuclide to be measured; acquiring the second activity concentration of the reference object under the current operating condition, wherein the second activity concentration of the reference object is obtained through experimental measurement of the activity concentration in the primary circuit; and, on the basis of the first activity concentration of the nuclide to be measured under the current operating condition, the first activity concentration of the reference object under the current operating condition and the second activity concentration of the reference object under the current operating condition, obtaining the second activity concentration of the nuclide to be measured under the current operating condition.

This embodiment provides a computer-readable storage medium. The computer-readable storage medium stores a computer program or instructions. When the computer program or instructions are executed by the processor, the computer performs the methods provided in each of the above-mentioned embodiments, for example, including: on the basis of the operating parameters of the current operating condition and the calculation parameters of the reference object, obtaining the first activity concentration of the reference object and on the basis of the operating parameters of the current operating condition and the calculation parameters of the nuclide to be measured, obtaining the first activity concentration of the nuclide to be measured; acquiring the second activity concentration of the reference object under the current operating condition, wherein the second activity concentration of the reference object is obtained through experimental measurement of the activity concentration in the primary circuit; and, on the basis of the first activity concentration of the nuclide to be measured under the current operating condition, the first activity concentration of the reference object under the current operating condition and the second activity concentration of the reference object under the current operating condition, obtaining the second activity concentration of the nuclide to be measured under the current operating condition.

Those skilled in the art should understand that embodiments of this disclosure may be provided as methods, systems, or computer program products. Therefore, this disclosure may be implemented in the form of fully-hardware embodiments, fully-software embodiments, or combined software-hardware embodiments. In addition, this disclosure may employ the form of a computer program product implemented on one or more computer-readable storage media (including but not limited to disk memory, CD-ROM, optical memory, and the like) containing computer programming code.

This invention is described with reference to the methods, devices (systems), and flowcharts and/or block diagrams of the computer program products according to the embodiments of the present invention. It should be understood that each process and/or box in the flowcharts and/or block diagrams, as well as the combinations of processes and/or boxes, can be implemented by computer program instructions. These computer program instructions can be provided to a general-purpose computer, a dedicated computer, an embedded processor, or other programmable data processing devices' processors to generate a machine, such that the instructions executed by the computer or other programmable data processing device's processor produce a device for performing the functions specified in one or multiple processes of the flowcharts and/or one or multiple boxes of the block diagrams.

These computer program instructions can also be stored in a computer-readable storage medium that can guide a computer or other programmable data processing device to operate in a specific manner. This stored instruction generates a product including an instruction device, which implements the functions specified in one or multiple processes of the flowcharts and/or one or multiple boxes of the block diagrams.

These computer program instructions can also be loaded onto computers or other programmable data processing devices, enabling a series of operation steps to be executed on the computer or other programmable device to generate the processing implemented by the computer, thereby the instructions executed on the computer or other programmable device provide steps for implementing the functions specified in one or multiple processes of the flowcharts and/or one or multiple boxes of the block diagrams.

In the description of this specification, the terms such as “an embodiment”, “a specific embodiment”, “some embodiments”, “for example”, “example”, “specific example”, or “some examples” indicate that the specific features, structures, materials or characteristics described in connection with such an embodiment or example are included in at least one embodiment or example of the present invention. In this specification, the illustrative expressions of the above terms do not necessarily refer to the same embodiment or example. Moreover, the specific features, structures, materials or characteristics described can be combined in any one or more embodiments or examples in an appropriate manner.

The above-mentioned specific embodiments further provide detailed explanations of the purpose, technical solution and beneficial effects of the present invention. It should be understood that the above are only specific embodiments of the present invention and do not limit the protection scope of the present invention. Any modifications, equivalents, substitutions, improvements, etc. within the spirit and principles of the present invention shall be included in the protection scope of the present invention.

What is claimed is:

1. A method for measuring an activity concentration in a primary circuit of a high temperature gas-cooled reactor, comprising:
on the basis of operating parameters of a current operating condition and calculation parameters of a reference object, obtaining a first activity concentration of the reference object under the current operating condition, and on the basis of the operating parameters of the current operating condition and calculation parameters of a nuclide to be measured, obtaining a first activity concentration of the nuclide to be measured under the current operating condition;
acquiring a second activity concentration of the reference object under the current operating condition, wherein the second activity concentration of the reference object under the current operating condition is obtained through experimental measurement of the activity concentration in the primary circuit;
on the basis of the first activity concentration of the nuclide to be measured under the current operating condition, the first activity concentration of the reference object under the current operating condition, and the second activity concentration of the reference object under the current operating condition, obtaining a second activity concentration of the nuclide to be measured under the current operating condition.

2. The method according to claim 1, wherein on the basis of the operating parameters of the current operating condition and calculation parameters of a target object, obtaining a first activity concentration of the target object under the current operating condition, comprising:
on the basis of the amounts of the target object produced from the pre-selected fissile nuclides and a coefficient corresponding to the target object, obtaining a core inventory of the target object, wherein the target object being a reference nuclide or a nuclide to be measured;
on the basis of a ratio of the release rate to the birth rate of halogen nuclides and fission gas nuclides in the equivalent failed coated particles and uranium contamination in the fuel elements in the core, obtaining an equivalent ratio of the release rate to the birth rate of all the fuel elements in the core;
on the basis of the decay constant, purification coefficient, deposition coefficient and neutron absorption cross section of the target object, as well as the purification flow rate of the helium purification system, the total volume of the helium in the primary circuit, the duration time per helium cycle, the leakage removal coefficient of the primary circuit, the core effective neutron flux and the duration time for the helium across the core per cycle under the current operating condition, obtaining an equivalent removal rate of the target object;
on the basis of the core inventory of the target object, the equivalent ratio of the release rate to the birth rate of all the fuel elements in the core, the equivalent removal rate of the target object and the total volume of the helium in the primary circuit, obtaining the first activity concentration of the target object under the current operating condition.

3. The method according to claim 2, wherein on the basis of the core inventory of the target object, the equivalent ratio of the release rate to the birth rate of all the fuel elements in the core, the equivalent removal rate of the target object and the total volume of the helium in the primary circuit, obtaining the first activity concentration of the target object under the current operating condition, comprising:
according to equation
$${A}_{ref} = \frac{{λ}_{eff} I \frac{R}{B} {\vert}_{t o t a l}}{V τ} ,$$
the first activity concentration of the target object under the current operating conditions A_{ref} is calculated, where λ_{eff} is the effective decay constant, I is the core inventory of the target nuclide,
$$\frac{R}{B} {\vert}_{total}$$
is the equivalent ratio of the release rate to the birth rate of all the fuel elements in the core, τ is the equivalent removal rate of the target nuclide, V is the total volume of the helium in the primary circuit, Δ_{eff}=λ+σₐφ₁, λ is the decay constant of the target nuclide, σₐ is the neutron absorption cross section of the target nuclide, and φ₁ is the core effective neutron flux.

4. The method according to claim 2, wherein on the basis of the decay constant, the purification coefficient, the deposition coefficient and the neutron absorption cross section of the target nuclide, as well as the purification flow rate of the helium purification system, the total volume of the helium in the primary circuit, the duration time per helium cycle, the leakage removal coefficient of the primary circuit, the core effective neutron flux, and the duration time for the helium across the core per cycle under the current operating condition, obtaining the equivalent removal rate of the target nuclide, comprising:
according to equation
$$τ = λ + ε \frac{Q}{V} + \frac{δ}{{t}_{c}} + ω + {σ}_{a} {ϕ}_{1} \frac{{t}_{v}}{{t}_{c}} ,$$
the equivalent removal rate τ of the target nuclide is calculated, where λ is the decay constant of the target nuclide, ε is the purification coefficient of the target nuclide, Q is the purification flow rate of the helium purification system, V is the total volume of the helium in the primary circuit, δ is the deposition coefficient of the target nuclide per cycle, t_{c} is the duration time per helium cycle, ω is the leakage removal coefficient of the primary circuit, σₐ is the neutron absorption cross section of the target nuclide, φ₁ is the core effective neutron flux, and tᵥ is the duration time for the helium across the core per cycle.

5. The method according to claim 2, wherein on the basis of a ratio of the release rate to the birth rate of halogen nuclides and fission gases in the equivalent failed coated particles and uranium contamination in the fuel elements in the core, obtaining an equivalent ratio of the release rate to the birth rate of all the fuel elements in the core, comprising:
according to equation
$$\frac{R}{B} {\vert}_{total} = F \frac{R}{B} {\vert}_{k e r n e l} + C \frac{R}{B} {\vert}_{nature} ,$$
the equivalent ratio of the release rate to the birth rate of all the fuel elements in the core,
$$\frac{R}{B} {\vert}_{total}$$
is obtained, where F is a failure fraction of the coated particles in the fuel elements in an HTGR, C is a share of uranium contamination in the matrix graphite of the fuel elements,
$$\frac{R}{B} {\vert}_{k e r n e l}$$
is a ratio of the release rate to the birth rate of halogen nuclides and fission gases in the equivalent sphere of a single failed coated particles, and
$$\frac{R}{B} {\vert}_{nature}$$
is a ratio of the release rate to the birth rate of halogen nuclides and fission gases in the equivalent sphere of uranium contamination in the matrix graphite.

6. The method according to claim 2, wherein on the basis of the amounts of the target object produced from the pre-selected fissile nuclides and the corresponding coefficient of the target object, obtaining the core inventory of the target object, comprising:
according to equation Iᵢ=ΣₖcₖA_{f,i,k}, the core inventory of nuclide i is obtained, where A_{f,i,k} is the amount of nuclide k produced from the pre-selected fissile nuclides, cₖ is the coefficient of A_{f,i,k} of the nuclide k in the decay chain of nuclide i, and k is the different nuclide designation in the decay chain of nuclide i.

7. The method according to claim 1, wherein the reference object is a fission-gas nuclide set, and correspondingly, on the basis of operating parameters of the current operating condition and calculation parameters of the fission-gas nuclide set, obtaining a first activity concentration of the fission-gas nuclide set under the current operating condition, comprising:
on the basis of the operating parameters of the current operating condition and calculation parameters of each nuclide in the fission-gas nuclide set, obtaining a first activity concentration corresponding to each nuclide in the fission-gas nuclide set;
summing the first activity concentrations corresponding to the nuclides in the fission-gas nuclide set to obtain the first activity concentration of the fission-gas nuclide set under the current operating condition.

8. The method according to claim 1, wherein on the basis of the first activity concentration of the nuclide to be measured under the current operating condition, the first activity concentration of the reference object under the current operating condition and the second activity concentration of the reference object under the current operating condition, obtaining the second activity concentration of the nuclide to be measured under the current operating condition, comprising:
according to equation
$${a}_{r , j} = \frac{{A}_{j}}{{A}_{r e f}} {a}_{ref} ,$$
the second activity concentration a_{r,j} of the nuclide to be measured under the current operating condition is obtained, where Aⱼ is the first activity concentration of the nuclide to be measured under the current operating condition, A_{ref} is the first activity concentration of the reference object under the current operating condition, and a_{ref} is the second activity concentration of the reference object under the current operating condition.

9. The method according to claim 1, wherein obtaining the second activity concentration of the reference object under the current operating condition through experimental measurement, comprising:
extracting coolant from the primary circuit under the current operating condition, and obtaining a nuclide spectrum from measurement, wherein the nuclides corresponding to the nuclide spectrum include the reference object;
analyzing the nuclide spectrum to obtain an activity concentration of the reference object in a sampling container;
correcting the activity concentration of the reference object in the sampling container on the basis of the sampling time and a density ratio between helium in the primary circuit and in the sampling container, so as to obtain the second activity concentration of the reference object under the current operating condition.

10. A computer device, comprising a memory, a processor and a computer program stored on the memory, wherein the processor is configured to execute the computer program so as to implement the method according to claim 1.

11. A computer-readable storage medium, wherein a computer program or instruction is stored on the computer-readable storage medium, the computer program or instruction being executed by a processor to implement the method according to claim 1.
